(19) United States
(12) Patent Application Publication
(10) Pub. No.: US 2009/0114436 A1
(43) Pub. Date: May 7, 2009

(54) SUBSTRATE STRUCTURE

(75) Inventors: Chia Ching CHEN, Kaohsiung City (TW); Yi Chuan DING, Kaohsiung (TW)

Correspondence Address: LOWE HAUPTMAN HAM & BERNER, LLP, 1700 DIAGONAL ROAD, SUITE 300, ALEXANDRIA, VA, 22314, US

(73) Assignee: ADVANCED SEMICONDUCTOR ENGINEERING, INC., KAOHSIUNG (TW)

(21) Appl. No.: 12/208,093

(22) Filed: Sep. 10, 2008

(30) Foreign Application Priority Data
Nov. 7, 2007 (TW) 096141979

(51) Int. Cl. H01R 12/04

(52) U.S. Cl. 174/263

(57) ABSTRACT

A substrate structure is provided. A plurality of solder pads is positioned on a substrate. A solder mask covers the substrate and has a plurality of openings to respectively expose portions of the solder pads, wherein the openings have the shape of a polygon of at least five sides.

### CROSS REFERENCE TO RELATED APPLICATION

This application claims the priority benefit of Taiwan Patent Application Serial Number 096141979 filed Nov. 7, 2007, the full disclosure of which is incorporated herein by reference.

### BACKGROUND OF THE INVENTION

1. Field of the Invention

The invention relates to a substrate structure and more particularly, to a substrate structure that the openings of the solder mask on the substrate have special shape.

2. Description of the Related Art

Miniaturization of semiconductor device size has been an important topic in the art when the device requires more I/O pins along with the increase of device density. Relatively, the ball grid array (BGA) package is an efficient packaging technology since it can provide more I/O pins.

Referring to FIGS. 1 and 2, the conventional BGA substrate 100 is provided with a plurality of solder pads 110 thereon arranged in the shape of a matrix. A solder mask 120 covers the substrate 100 and has a plurality of openings to respectively expose the solder pads 110. Referring to FIG. 3, when the substrate 100 is designed to electrically connect to another substrate or a circuit board, the solder pads 110 is provided with a plurality of solder balls 130 thereon, respectively. The solder balls 130 will be bonded with the electrical terminals of the circuit board to have the substrate 100 electrically connected to the circuit board (not shown in the figure).

To avoid the separation of the solder balls 130 from the solder pads 110, the exposed portions of the solder pads 110 are required to be large enough so as to provide strong bonding with the solder balls 130. However, when the exposed portions of the solder pads 110 are increased, the adjacent solder balls 130 are likely to be very close to and therefore connect with each other to cause a fatal short circuit (see FIG. 3).

### SUMMARY OF THE INVENTION

It is an object of the present invention to provide a substrate structure, wherein the openings of the solder mask on the substrate to expose the solder pads have special shape thereby preventing adjacent solder balls from connecting to each other and increasing the bonding between the solder balls and solder pads.

In order to achieve the above object, the substrate structure of the present invention is provided with a plurality of solder pads thereon arranged in the shape of a matrix. A solder mask covers the substrate and has a plurality of openings to respectively expose the portions of the solder pads, wherein the openings have the shape of a polygon of at least five sides, such as an octagon, ten-sided polygon or dodecagon. Preferably, the openings have the shape of a polygon whose interior angles are all obtuse. In addition, the edges of the solder pads are all covered by the solder mask. The distance between the edges of the solder pads and the edges of the corresponding openings is at least about 20 μm to prevent the openings from directly exposing the surface of the substrate.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a top view of a conventional BGA substrate provided with a plurality of solder pads thereon arranged in the shape of a matrix.

FIG. 2 is a cross-sectional view taken from the line 2-2 of FIG. 1.

FIG. 3 is the BGA substrate of FIG. 2, wherein the solder balls are positioned on the solder pads.

FIG. 4 is a top view of the substrate structure of the present invention that is provided with a plurality of solder pads thereon arranged in the shape of a matrix, wherein the openings on the solder mask have the shape of an octagon.

FIG. 5 is a cross-sectional view taken from the lines 5-5 of FIGS. 4, 6 and 7.

FIG. 6 is a top view of the substrate structure of the present invention that is provided with a plurality of solder pads thereon arranged in the shape of a matrix, wherein the openings on the solder mask have the shape of a ten-sided polygon.

FIG. 7 is a top view of the substrate structure of the present invention that is provided with a plurality of solder pads thereon arranged in the shape of a matrix, wherein the openings on the solder mask have the shape of a dodecagon.

FIG. 8 illustrates the openings with the shape of a circle to expose the corresponding solder pads in the art and the openings with the shape of a polygon to expose the corresponding solder pads according to the present invention.

FIG. 9 is a cross-sectional view of the substrate structure of the present invention, wherein the openings expose the surface of the substrate due to deviation.

FIG. 10a illustrates that the octagonal opening on the solder mask on the substrate according to present invention deviates from its predetermined position.

FIG. 10b illustrates that the ten-sided opening on the solder mask on the substrate according to present invention deviates from its predetermined position.

FIG. 10c illustrates that the dodecagonal opening on the solder mask on the substrate according to present invention deviates from its predetermined position.

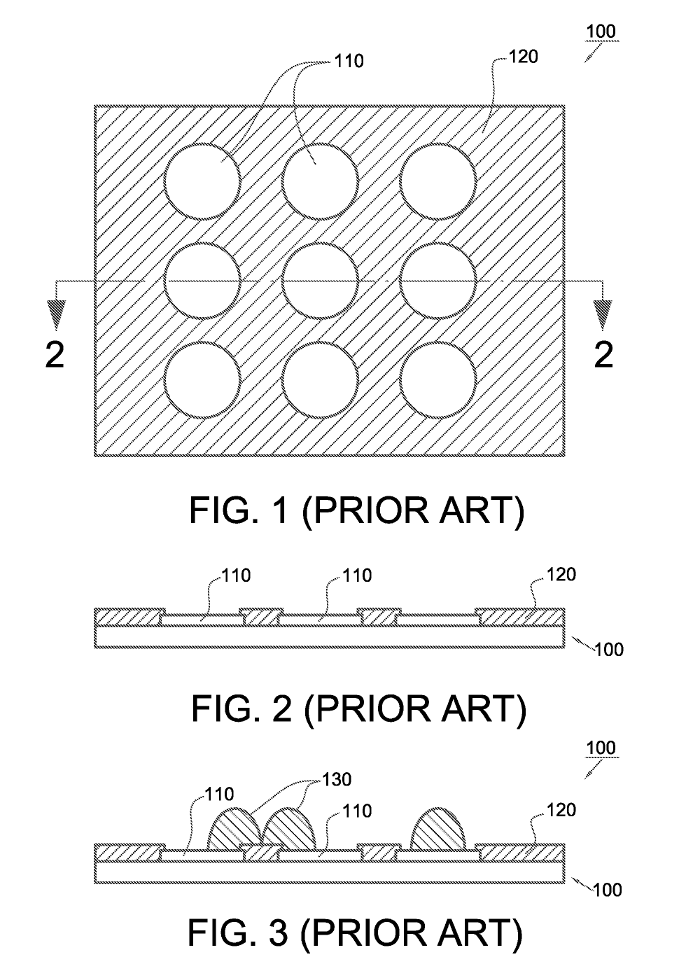

### DETAILED DESCRIPTION OF THE PREFERRED EMBODIMENT

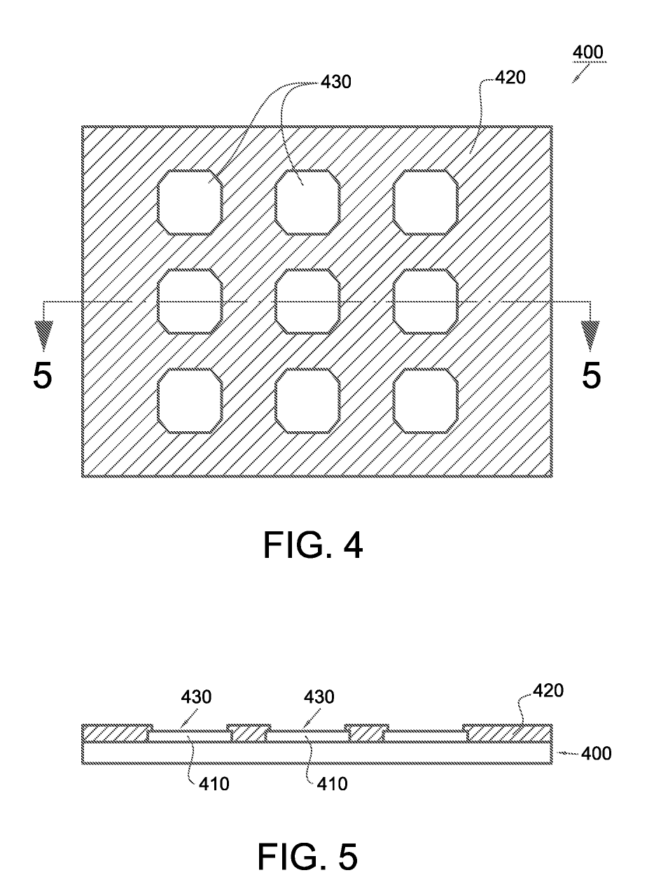

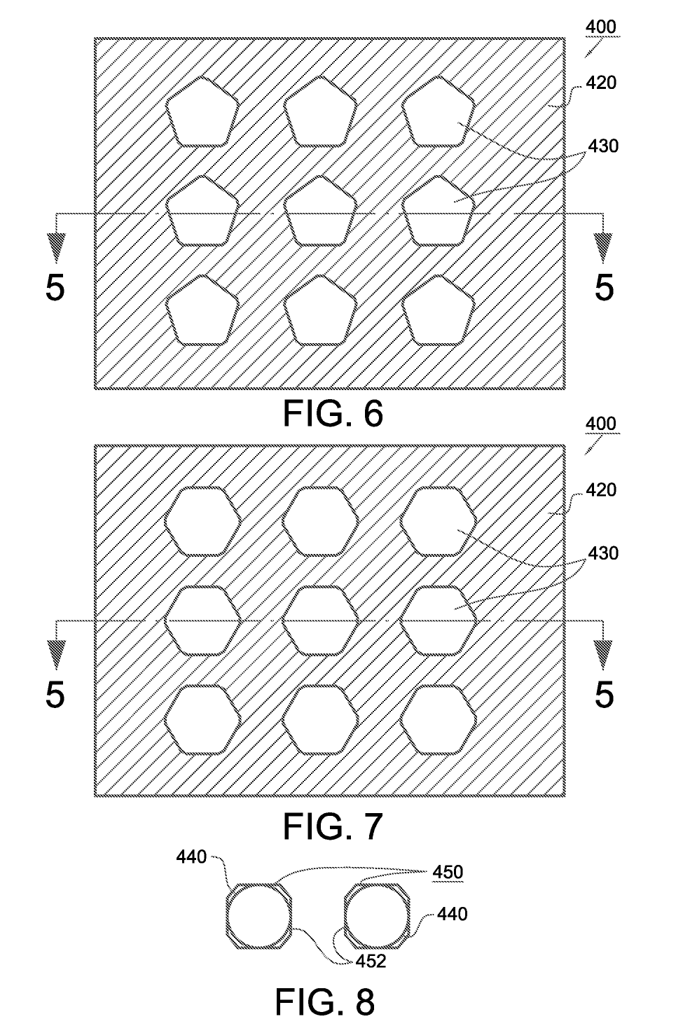

Referring to FIGS. 4 and 5, the substrate structure 400 of the present invention is provided with a plurality of solder pads 410 thereon arranged in the shape of a matrix. A solder mask 420 covers the substrate 400 and has a plurality of openings 430 to respectively expose the portions of the solder pads 410, wherein the openings 430 have the shape of a polygon of at least five sides, such as an octagon. Besides, referring to FIGS. 6 and 7, the openings 430 can also be a ten-sided polygon or dodecagon.

To better illustrate the advantage of the present invention, FIG. 8 shows two openings with the shape of a circle 440 to expose the corresponding solder pads in the art and two openings with the shape of a polygon 450 to expose the corresponding solder pads according to the present invention. The polygons 450 are arranged in such a manner that the nearest sides 452 of the two polygons 450 are parallel to each other. As can be seen from the figure, the shortest distance between the two sides 452 are equal to that between the two circles 440 while the areas of the polygons 450 are greater than the areas of the circles 440. More specifically, when the shortest distance between the exposed portions of two adjacent solder pads remains unchanged, the solder pads 410 of the present invention can provide larger bonding area. Therefore, the bonding between the solder pads 410 and the solder balls can be increased without putting two adjacent solder pads 410 at being very close to each other. This will prevent the solder balls on the adjacent solder pads 410 from connecting to each other during ball-mounting. Besides, it is usually required to apply flux to facilitate the mounting of the solder balls on the solder pads 410. The substrate 400 is required to be cleaned to remove the flux so as to avoid adverse effect on the substrate 400 after the solder balls have been mounted. Since the flux often remains on the acute corners of the solder pad and therefore is not easy to be cleaned away, it is preferred that the exposed portions of the solder pads 410 from the solder mask 420 have the shape of a polygon whose interior angles are all obtuse, i.e. greater than 90 degrees.

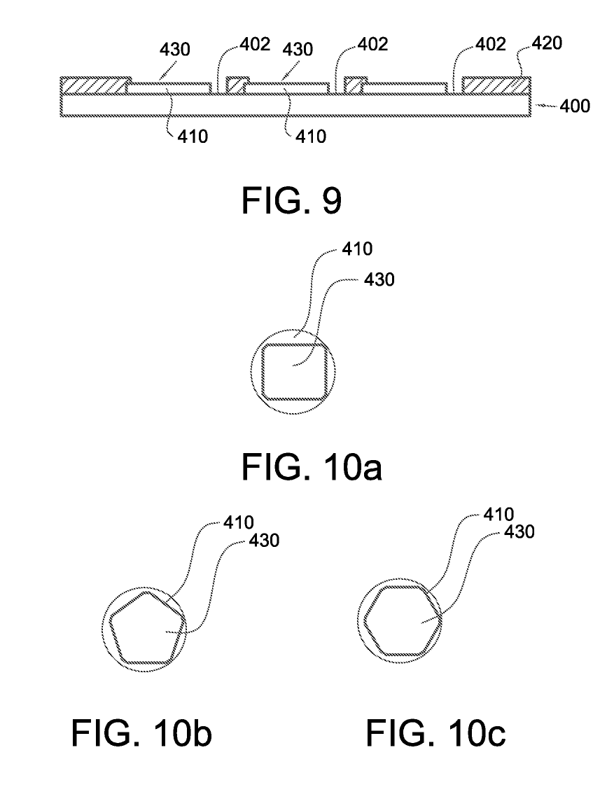

Referring to FIG. 5 again, the method for manufacturing the substrate 400 of the present invention is first to form a plurality of solder pads 410 on the substrate 400, wherein the solder pads 410 are arranged in the shape of a matrix. A solder mask 420 then covers the substrate 400. Since the solder pads 410 are covered by the solder mask 420, it is required to form a plurality of openings 430 on the solder mask 420 so as to respectively expose the solder pads 410. In order to form the openings 430, a photomask is required to be used and then the solder mask 420 is processed by exposing and developing. It is best that the edges of the solder pads 410 are all covered by the solder mask 420. Specifically, the openings 430 expose only the solder pads 410 but not the substrate 400 or other structures on the substrate 400. However, the openings 430 usually fail to form on the predetermined positions on the substrate 400. Referring to FIG. 9, when the openings 430 deviate from their respective predetermined positions, the surface 402 of the substrate 400 may be exposed from the openings 430. This may cause the solder balls to be in direct contact with the surface 402 of the substrate 400 after ball-mounting and lead to an adverse effect on the substrate 400. To prevent the openings 430 from deviation and therefore directly exposing the surface 402 of the substrate 400, it is preferred that the sides of the openings 430 are alternately short and long. For example, the openings 430 can be an octagon, ten-sided polygon or dodecagon formed by cutting the corners of a square, regular pentagon or regular hexagon, respectively. In this way, when the openings 430 deviate from their respective predetermined positions due to certain causes occurred in the photomask, exposure and/or development processes, a slight deviation of the openings 430 will not cause the surface 402 of the substrate 400 to be directly exposed as can be seen from the FIGS. 10a, 10b and 10c. It should be noted that the edges of the solder pads 410 are required to be positioned away from the edges of the corresponding openings 430 for a minimal distance so that the edges of the solder pads 410 are all covered by the solder mask 420. It is preferred that the minimal distance is at least about 20 μm to prevent the openings 430 from directly exposing the surface 402 of the substrate 400.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A substrate structure, comprising:
a substrate;
a plurality of solder pads disposed on the substrate; and
a solder mask covering the substrate and having a plurality of openings to expose the solder pads, respectively,
wherein the openings have the shape of a polygon of at least five sides.

2. The substrate structure as claimed in claim 1, wherein the polygons are selected from the group consisting of octagon, ten-sided polygon or dodecagon.

3. The substrate structure as claimed in claim 1, wherein all the interior angles of the polygons are obtuse.

4. The substrate structure as claimed in claim 2, wherein all the interior angles of the polygons are obtuse.

5. The substrate structure as claimed in claim 1, wherein the each two adjacent polygons have respective nearest sides, the two nearest sides are parallel to each other.

6. The substrate structure as claimed in claim 2, wherein the each two adjacent polygons have respective nearest sides, the two nearest sides are parallel to each other.

7. The substrate structure as claimed in claim 1, wherein the edges of the solder pads are all covered by the solder mask.

8. The substrate structure as claimed in claim 7, wherein the distance between the edges of the solder pads and the edges of the corresponding openings is at least about 20 μm.
